(19) United States
(12) Patent Application Publication
(10) Pub. No.: US 2006/0036678 A1
(43) Pub. Date: Feb. 16, 2006

(54) Method for remote controlling and watching of displaying apparatus and system employing the same

(75) Inventors: Eun-hee Rhim, Suwon-si (KR); Kee-wook Na, Anyang-si (KR); Jong-won Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/197,350

(22) Filed: Aug. 5, 2005

(30) Foreign Application Priority Data
Aug. 13, 2004 (KR) 10-2004-0063878

(51) Int. Cl. G06F 15/16

(52) U.S. Cl. 709/203

(57) ABSTRACT

A system and a method for more efficiently supplying content and remotely controlling and watching multiple displaying apparatuses. The method includes supplying control information to control a displaying apparatus connected by a network, creating a remote control message including the supplied control information and transmit it to the displaying apparatus, receiving a state information message including state information of the displaying apparatus from the displaying apparatus, in response to the remote control message, and interpreting the state information message and supplying the state information.

### CROSS-REFERENCE TO RELATED APPLICATIONS

This application claims priority from Korean Patent Application No. 10-2004-0063878 filed on Aug. 13, 2004, the disclosure of which is incorporated herein in its entirety by reference.

### BACKGROUND OF THE INVENTION

1. Field of the Invention

Apparatuses and methods consistent with the present invention relates to displaying a content. More particularly, exemplary embodiments of the present invention relate to a system and a method for more efficiently supplying a content and remotely controlling and watching multiple displaying apparatuses, by allowing a server and the multiple displaying apparatuses interconnected by a network to perform predetermined message communications.

2. Description of the Related Art

FIG. 1 schematically illustrates a conventional system supplying a service for displaying content.

The conventional system 100 comprises displaying apparatuses 110, 130 and 150 and servers 120, 140 and 160 respectively connected to each of the displaying apparatuses 110, 130 and 150, to thereby supply a content to the displaying apparatuses 110, 130 and 150. The content comprises multimedia data (e.g., music, image, moving pictures) as well as data in various text formats.

The respective servers 120, 140 and 160 have a variety of software programs built therein or independent hardware mounted thereon, to thereby convert any format of the content stored therein into such a format suitable for being outputted by the displaying apparatuses 110, 130 and 150. An output format of the content selected by a user, among the contents contained in the servers 120, 140 and 160, is converted by the software program or the hardware, and the converted content is outputted by the displaying apparatuses 110, 130 and 150.

The user may search contents stored in the servers 120, 140 and 160, making use of the displaying apparatuses 110, 130 and 150. A searched content is transmitted to the displaying apparatuses 110, 130 and 150 from the servers 120, 140 and 160, and the displaying apparatuses 110, 130 and 150 can output the transmitted content to the user. In this case, each of the displaying apparatuses 110, 130 and 150 functions as a client. A method of providing such a service for displaying a content between a client and a server is illustrated in FIG. 2.

While a server is in operation, a client connects the server with the use of an address and port information of the server S210, and requests any service from the server S220. Then, the server searches for the requested service, and supplies the searched service to the client S230.

According to the conventional system, as illustrated in FIG. 1, each of the displaying apparatuses needs a server having a function to convert a format of the content adaptively for its own use. Therefore, a user has to select any content to be outputted directly from the displaying apparatus, causing inconvenience to the user. In the system having a client-server configuration as illustrated in FIG. 2, the server has difficulty controlling a displaying apparatus corresponding to a client or watching any change caused in physical states of the displaying apparatus.

Meanwhile, a displaying apparatus may be controlled through a server by means of a universal plug-and-play (UPnP) home network standard. For example, Korean Unexamined Patent Publication No. 2004-0091368 entitled “Remote controlling method and system for device in home network” discloses supplying a device discovery interworking function between an agent existing in a home network and a server existing on the internet, thereby enabling description information of a UPnP device within the home network to be confirmed on the web and directly accessing any target device desired in a remote manner.

However, the UPnP applicable environment as disclosed in the above-described publication is embodied by use of a HyperText Markup Language (HTML), and thus, a server and a displaying apparatus are in need of an HTML browser and a parser to interpret a message set used in the UPnP. In addition, in order to perform the UPnP protocol, hardware or software equivalent in performance to an HTTP server is required by the server and the displaying apparatus.

In this case, they are effective only when the message set regarding remote control commands is defined in the UPnP, whereby many restrictions would be imposed on extension of remote control commands, and also on watching by the server of any change in the state of the displaying apparatus. Even in performing a simple remote control command, there is a need of an HTTP server to perform the UPnP protocol and a software program such as an HTML parser.

Under the circumstances, a system and a server need a message communication method for efficiently supplying the content to a displaying apparatus and remotely controlling and watching a state of the displaying apparatus.

### SUMMARY OF THE INVENTION

The present invention has been conceived to solve the problems described above.

An object of the present invention is to remotely control multiple displaying apparatuses each having a message communication function from a single server and watch any change caused in physical state of the displaying apparatus.

The present invention will not be limited to the technical object described above. Other objects not described herein will be understood by those in the art from the following detailed description.

According to an aspect of the present invention, there is provided a server comprising a remote control module that supplies control information to control a displaying apparatus connected to the server by a network, a server agent module that creates a remote control message containing the supplied control information, a network interface module that transmits a specific message created by the server agent module to the displaying apparatus, and receives a state information message containing state information of the displaying apparatus from the displaying apparatus, and a remote watch module that manages the state information included in the received state information message.

According to another aspect of the present invention, there is provided a displaying apparatus comprising a device interface module that transmits data to, and receives data from, a server connected to the displaying apparatus by a network, a state information collecting module that senses any change in state of the displaying apparatus, collects predetermined state information and outputs it, a device agent module that interprets the received data if they include a remote control message containing control information, and creates a state information message containing the received state information, and a control module that performs state control of the displaying apparatus according to the outputted control information.

According to a further aspect of the present invention, there is provided a method for remote controlling and watching, comprising supplying control information to control a displaying apparatus connected by a network, creating a remote control message including the supplied control information and transmitting it to the displaying apparatus, receiving a state information message including state information of the displaying apparatus from the displaying apparatus, in response to the remote control message, and interpreting the state information message and supplying the state information.

According to a still further aspect of the present invention, there is provided a method for remote controlling and watching, comprising receiving a predetermined message from a server connected by a network, controlling a state of a displaying apparatus where the message is a remote control message to control a state of the displaying apparatus, collecting state information of the displaying apparatus changed according to the control, and creating a state information message including the state information and transmitting the message to the server.

### BRIEF DESCRIPTION OF THE DRAWINGS

The above aspects and other features and advantages of the present invention will become more apparent by describing in detail exemplary embodiments thereof with reference to the attached drawings in which:

FIG. 1 schematically illustrates a conventional system for displaying a content and providing a service;

FIG. 2 illustrates a method of providing the service between a client and a server according to the conventional system;

FIG. 3 schematically illustrates a system to provide a content displaying service according to an exemplary embodiment of the present invention;

FIG. 4 illustrates a structure of a displaying apparatus and a server to provide the content displaying service according to an exemplary embodiment of the present invention;

FIG. 5A is a block diagram illustrating a control and watch module 435 of FIG. 4;

FIG. 5B is a block diagram illustrating a remote control and watch module 480 of FIG. 4;

FIG. 6 illustrates registering a service of the client according to an exemplary embodiment of the present invention;

FIG. 7 illustrates a Pull mode service performed according to an exemplary embodiment of the present invention;

FIG. 8 illustrates a Push mode service performed according to an exemplary embodiment of the present invention;

FIG. 9 illustrates performing a remote control service according to an exemplary embodiment of the present invention;

FIG. 10 is a flow chart illustrating the remote control and watch according to an exemplary embodiment of the present invention; and

FIGS. 11A and 11B illustrate termination of the service according to an exemplary embodiment of the present invention.

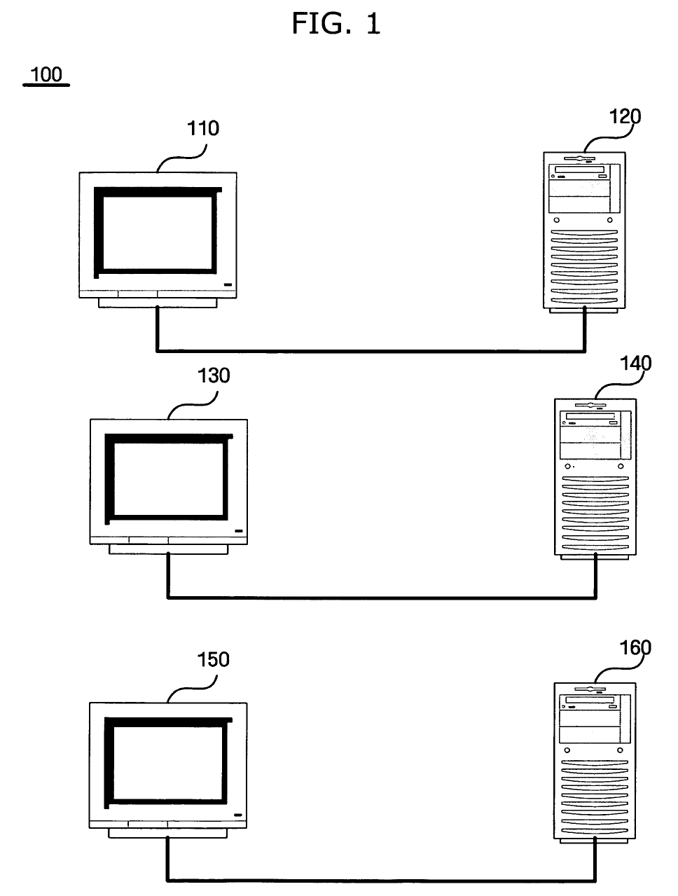

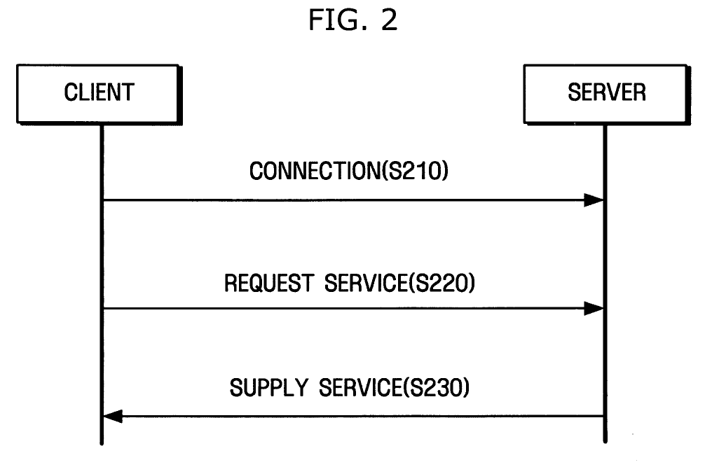

### DETAILED DESCRIPTION OF EXEMPLARY EMBODIMENTS OF THE INVENTION

Subject matters of exemplary embodiments will be covered by the detailed description and drawings of the present invention.

Advantages and features of the present invention and methods of accomplishing the same may be understood more readily by reference to the following detailed description of exemplary embodiments to be described in detail and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinbelow, the content displaying system and method according to exemplary embodiments of the present invention will be described, referring to block diagrams and flow charts illustrated in the accompanying drawings. At this time, it can be apprehended that combinations of each block of flow chart diagrams and flow charts can be executed by computer program instructions. Since these computer program instructions may be installed on universal purpose computers, special purpose computers or other programmable data processing equipment, any tool can be constructed so that the instructions performed through computers or processors of other programmable data processing equipment can generate means to perform functions described in the flow charts or blocks. These computer program instructions may be stored in computer usable or computer readable memories to realize the functions in any specific method. The instructions stored in the computer usable or computer readable memories may be manufactured as products including instruction means to perform functions described in the flow charts and blocks. The computer program instructions may be installed on computers or other programmable data processing equipment. The instructions may create processes performed by computers by executing a series of operations on computers or other programmable data processing equipment and operate the computers, or other programmable data processing equipment may also supply operations to perform the functions described in the flow charts or blocks.

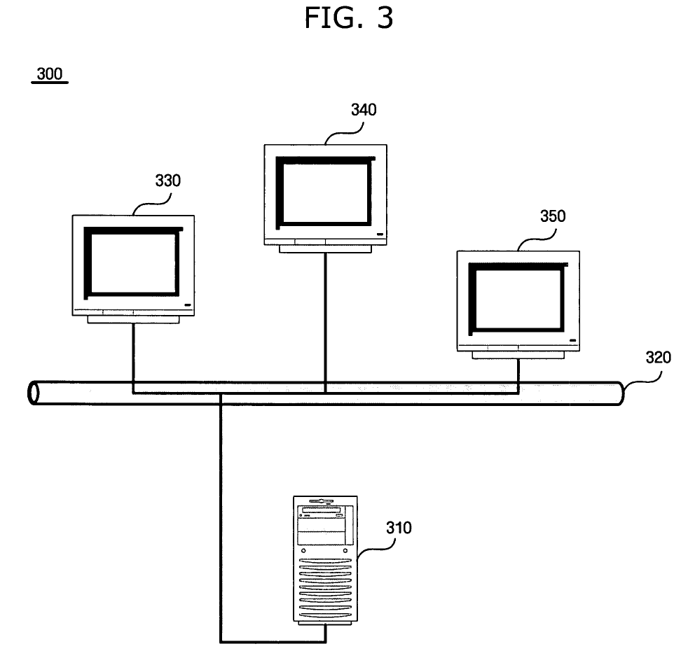

FIG. 3 schematically illustrates a system of providing a content displaying service according to an exemplary embodiment of the present invention.

The system 300 is connected to plural displaying apparatuses 330, 340 and 350 which receive a content from the server 310 and output the content through a transmitting medium 320. The displaying apparatus may be a large-sized display such as a television set, a monitor, or an electric signboard.

Unlike the conventional system, the server 310 supplies a content stored therein to a corresponding displaying apparatus according to a predetermined schedule, and the displaying apparatus having received the content converts the received content adaptively to its own output format and then outputs it. According to this, the displaying apparatuses comprise hardware or software that can convert the content to data of various formats.

In addition, the server 310 can remotely control the displaying apparatuses 330, 340 and 350, and watch for various changes in states of the displaying apparatuses 330, 340 and 350.

Information may be transmitted or received between the server 310 and the displaying apparatuses 330, 340 and 350, using message communications which will be described later.

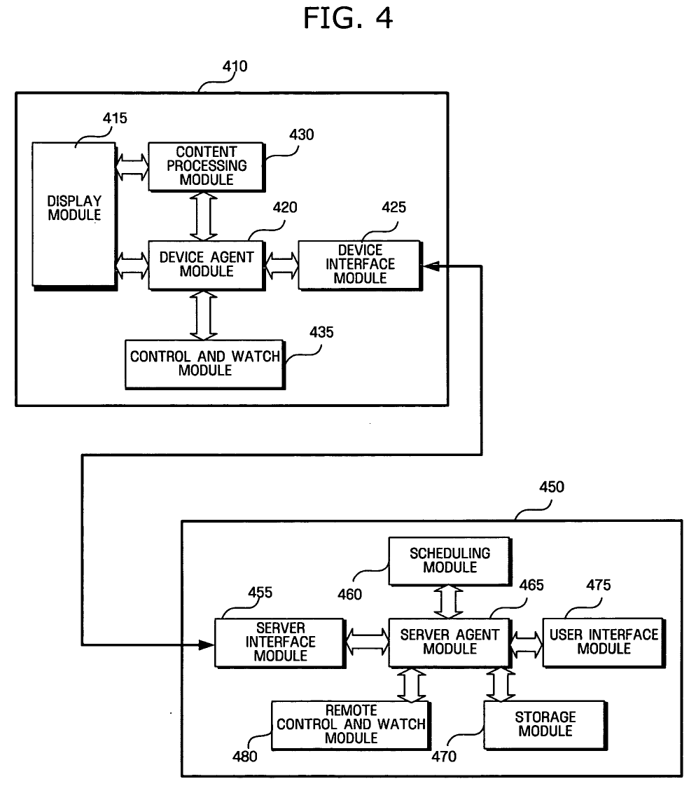

FIG. 4 illustrates a structure of a displaying apparatus and a server to provide a content displaying service according to an exemplary embodiment of the present invention.

The displaying apparatus 410 comprises a display module 415, a device agent module 420, a device interface module 425, a content processing module 430 and a control and watch module 435.

The display module 415 displays a content received from the server 450, and provides a means to allow a user to request a specific content stored in the server 450.

The device interface module 425 automatically senses other displaying apparatuses (not shown) and a server interconnected through a network, extracts information about the displaying apparatuses and the server sensed, and performs message communications with the displaying apparatuses and the server 450.

The content processing module 430 converts the content received from the server 450 adaptively to the output format of the displaying apparatus 410, and transmits the converted content to the display module 415.

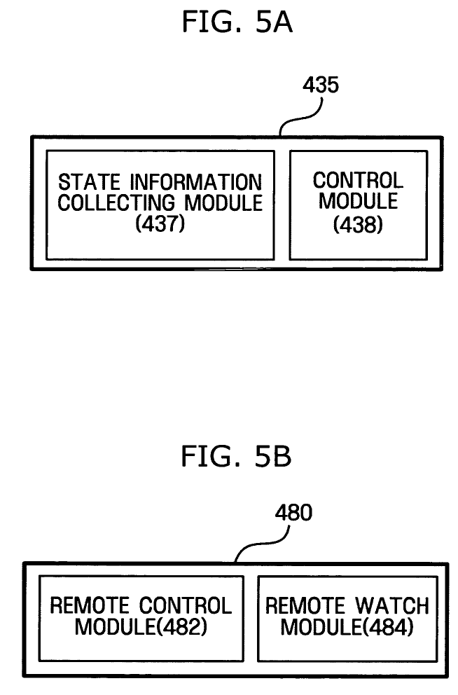

When the displaying apparatus 410 receives a remote control message from the server 450, the control and watch module 435 performs an operation according to the control command contained in the remote control message, or performs a function to sense any change in the state of the displaying apparatus 410. As illustrated in FIG. 5A, the control and watch module 435 may comprise a state information collecting module 437 and a control module 438, which will be described later.

The device agent module 420 interprets messages received from the server 450, and creates a message to be transmitted to the server 450. Further, the device agent module 420 coordinates the display module 415, the control and watch module 435, and the content processing module 430 so as to allow facilitation of operations among the modules.

The server 450 comprises a server interface module 455, a scheduling module 460, a server agent module 465, a storage module 470, a user interface module 475, and a remote control and watch module 480.

The server interface module 455 automatically senses multiple displaying apparatuses interconnected through a network, extracts information about the displaying apparatuses sensed, and performs message communications with the displaying apparatuses.

The storage module 470 stores therein sound, image and video files such as music, photographs, moving pictures, or text files in various formats.

The user interface module 475 provides a means to allow a user to search contents stored in the storage module 470 based on a keyword or an index, and a means to allow the user to manage a schedule about which content is transmitted to which displaying apparatus at what time. In addition, the user interface module 475 provides a means to allow the user to remotely control plural displaying apparatuses and also a means to display any state information of the plural displaying apparatuses.

The scheduling module 460 functions to transmit a specific content to any designated displaying apparatus at any fixed time according to the schedule.

The server agent module 465 interprets the messages transmitted from the displaying apparatus 410, and creates a message to be transmitted to the displaying apparatus 410. In addition, the server agent module 465 coordinates the user interface module 475, the scheduling module 460 and the storage module 470 for smooth operations among them.

The remote control and watch module 480 outputs control information to control the displaying apparatus 410 to the server agent module 465, and manages state information transmitted from the displaying apparatus 410. As illustrated in FIG. 5B, the remote control and watch module 480 may comprise a remote control module 482 and a remote watch module 484, which will be described later.

The term ‘module’, as used herein, means, but is not limited to, a software or hardware component, such as a Field Programmable Gate Array(FPGA) or Application Specific Integrated Circuit(ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Hereinbelow, operations between modules will be described in detail. For the sake of convenience, an operation for content display and an operation for remote control and watch will be described.

1. Content Displaying Service

(1) Mutual Recognition Between a Displaying Apparatus and a Server

The server 450 and the displaying apparatus 410 are interconnected to form a single network group through the server interface module 455 and the device interface module 425 respectively. At this time, the server 450 may be connected to plural displaying apparatuses, but it will be assumed, for convenience, that the server 450 is connected to a single displaying apparatus. The internal blocks of other displaying apparatuses are construed to be identical to those of the displaying apparatus 410 illustrated in FIG. 4.

The server interface module 455 senses whether power is applied to the displaying apparatus 410 and the displaying apparatus 410 is at the operable state. The device interface module 425 senses whether power is applied to the server 450 and the server 450 is at the operable state. For example, in the case of the server 450, if the server interface module 455 senses the displaying apparatus 410 and transmits the sensed result to the server agent module 465, the server agent module 465 provides the user with information about a state of the displaying apparatus 410 through the user interface module 475. According to this, the user can ascertain states of the respective displaying apparatuses in the same place on which the server 450 is located, without making a direct tour of the displaying apparatuses.

(2) Scheduling

At first, the user searches for a content stored in the storage module 470 based on a keyword or an index by means of the user interface module 475 so as to display the content on the displaying apparatus 410. The user determines at which time to display the searched content on the displaying apparatus 410 and inputs it through the user interface module 475.

Scheduling information created by the user's input includes information about the searched content, the time to display the searched content, the displaying apparatus to display the searched content thereon. The scheduling information is managed by the scheduling module 460. Thus, as the time to display the content is approaching as indicated by the scheduling information, the scheduling module 460 transmits the scheduling information to the server agent module 465. The server agent module 465 extracts the content designated by the scheduling information from the storage module 470, and transmits it to the displaying apparatus as designated by the scheduling information through the server interface module 455.

(3) Content Outputting

When the displaying apparatus 410 has received data from the server 450 through the device interface module 425, the device agent module 420 first determines whether the received data is designed to output the content or to control the displaying apparatus 410.

Where the received data is designed to output the content, in other words, the concerned content is transmitted from the server 450, the device agent module 420 transmits the received data to the content processing module 430.

The content processing module 430 converts the data received from the device agent module 420 into an output format adaptive to the displaying apparatus 410, and derives an application program to output the converted content. The content played by the application program is provided to the user through the display module 415.

The user of the displaying apparatus 410 may request any target content desired from the server 450 through the display module 415. In this case, the display module 415 has a means to receive the content information inputted by the user. At this time, the displaying apparatus 410 may receive a list of contents stored in the storage module 470 of the server 450 in advance from the server 450, and upon receiving a request from the user, it may provide the list to the user through the display module 415. As another exemplary embodiment, the displaying apparatus 410 may request the server 450 to provide the list of contents stored in the storage module 470 only upon receiving the user's request.

### (4) EXAMPLES

Exemplary embodiments of the present invention may be applied to various fields. Several examples will be described.

a) Cyber Galleries

The server 450 converts works kept by museums of art and the like into image data of high quality and stores them in the storage module 470. Displaying apparatuses are positioned at those publicly available spaces for galleries or showrooms to exhibit the works, and they are connected to the server 450 through a network.

The user determines scheduling information containing the order to display the image data and their contents on the respective displaying apparatuses, through the user interface module 475, and the scheduling information determined by the user is registered in the scheduling module 460. When the time as determined is approaching, the scheduling module 460 transmits the concerned scheduling information to the server agent module 465. The server agent module 465 extracts image data designated through the scheduling information from the storage module 470, and transmits the extracted image data to the displaying apparatus designated according to the scheduling information through the server interface module 455, so that the user can appreciate pictures displayed.

b) Airport Information Service

The server 450 stores contents such as airport guide and flight information, advertisements, and video/audio for entertainment, etc. in the storage module 470. The displaying apparatuses are installed where they are required within an airport, and connected to the server 450 through a network.

The scheduling module 460 of the server 450 manages the order of the content to be supplied to the respective displaying apparatuses.

When the time as designated by the scheduling information has arrived, the server 450 transmits the concerned content to any designated displaying apparatus, and the displaying apparatus converts the received content in the adaptive format and outputs it on the screen.

c) Presentation Information Service

The server 450 stores contents of guide and introduction materials for presentation in the storage module 470. The displaying apparatuses are installed where they are required within publicly available spaces and connected to the server 450 through a network.

The scheduling module 460 of the server 450 manages the order and the content of the presentation to be supplied to the respective displaying apparatuses.

When the time as designated by the scheduling information has arrived, the server 450 transmits the concerned content to any designated displaying apparatus, and the displaying apparatus converts the received content in the adaptive format and outputs it on the screen.

2. Remote Control and Watch

The server 450 may remotely control the displaying apparatus 410. For this purpose, the server 450 and the displaying apparatus 410 both have message sets for remote control, which will be described later. The server 450 may also ascertain state information of the displaying apparatus 410. In describing the present invention, the term “state information” indicates operational conditions of the displaying apparatus, covering network connection states between a server and a displaying apparatus, service conditions of the displaying apparatus, information of the content outputted from the displaying apparatus, power on/off state, volume, brightness, and contrast of the displaying apparatus, etc.

To perform the remote control and watch function, the remote control and watch module 480 of the server 450 may comprise a remote control module 482 and a remote watch module 484.

At this time, the user interface module 475 provides an interface with which the user is allowed to control the displaying apparatus 410 or to know state information of the displaying apparatus 410.

The server agent module 465 creates a remote control message containing control information to control the displaying apparatus 410 or interprets the state information message received from the displaying apparatus 410.

The remote control module 482 transmits control information adaptive to control conditions of the displaying apparatus determined through the user interface module 475 to the server agent module 465.

The remote watch module 484 outputs state information of the displaying apparatus 410 interpreted by the server agent module 465, to the user interface module 475.

The control and watch module 435 of the displaying apparatus 410 comprises a state information collecting module 437 and a control module 438.

The device agent module 420 may create a state information message containing state information of the displaying apparatus 410 or interpret the remote control message received from the server 450.

The control module 438 controls the displaying apparatus 410 according to the remote control message interpreted by the device agent module 420.

The state information collecting module 437 senses any change in states of the displaying apparatus 410 and transmits it to the device agent module 420.

Remote control and watch operations associated with the displaying apparatus 410 will be described based on (1) remote control by a user of the displaying apparatus, and (2) watch for state changes of the displaying apparatus.

(1) Remote Control by a User of the Displaying Apparatus

When the user desires to turn off the power of a specific displaying apparatus, he or she may ascertain power state of the respective displaying apparatus through the user interface provided by the user interface module 475.

Afterwards, if the user sets up through the user interface module 475 so that power of a specific displaying apparatus 410 is turned off, the remote control module 484 transmits the concerned control information to the server agent module 465. The server agent module 465 creates a remote control message containing the control information and transmits it to the displaying apparatus 410 through the server interface module 455.

When the displaying apparatus 410 receives the remote control message through the device interface module 425, the device agent module 420 interprets the received message. If the interpreted message contains control information, the device agent module 420 transmits the concerned control information to the control module 438. The control information transmitted from the device agent module 420 relates to power off, and thus, the control module 438 turns off power of the displaying apparatus 410.

In this way, the server 450 may remotely control states of the displaying apparatus, by adjusting values of volume, contrast, brightness of the displaying apparatus, or monitor input.

(2) Watch for State Changes of the Displaying Apparatus 410

If the control module 438 performs a control operation corresponding to the remote control message received from the server 450, associated with the displaying apparatus 410, the state information collecting module 437 senses any change in states of the displaying apparatus 410 (e.g., volume, brightness, etc.), collects information about them, and transmits the collected information to the device agent module 420. The device agent module 420 creates a state information message containing state information of the displaying apparatus 410 transmitted from the state information collecting module 437, and transmits it to the server through the device interface module 425.

The state information collecting module 437 of the displaying apparatus 410 may collect state information of the displaying apparatus 410 although a control command is not received from the server 450, and transmit the information to the device agent module 420. For example, the displaying apparatus 410 may comprise a user interface module (not shown) so as to allow the user to directly control states of the displaying apparatus 410. At this time, if the user directly controls the states of the displaying apparatus 410 through the user interface module of the displaying apparatus 410, the state information collecting module 437 may sense any change in states of the displaying apparatus 410, collect the concerned state information, and transmit it to the device agent module 420. Furthermore, the state information collecting module 437 may collect state information of the displaying apparatus 410 every time as set up in advance, and transmit it to the device agent module 420.

The device agent module 420 transmits a state information message including the state information received to the server 450 through the device interface module 425.

The server agent module 465 having received the state information message of the displaying apparatus 410 through the server interface module 455 interprets the received message and transmits the state information of the displaying apparatus 410 to the remote watch module 484. The remote watch module 484 may manage the state information collected from the respective displaying apparatuses. The remote watch module 484 may also display the state information of the displaying apparatus 410 to the user through the user interface module 475. According to this, the user can remotely watch the state of the displaying apparatus 410 through the server 450.

The server 450 may request regularly or irregularly (e.g., upon receiving a request from the user) state information of a specific displaying apparatus from the specific displaying apparatus. In this case, the remote watch module 484 may designate identification information of any target displaying apparatus desired to receive its state information and the kind of desired state information to receive, and transmits it to the server agent module 465. The server agent module 465 may create a state information requesting message containing the identification information and the kind of the state information, and transmit it to the displaying apparatus corresponding to the identification information through the server interface module 455.

If the device interface module 425 receives the state information requesting message, the device agent module 420 interprets the message and transmits it to the state information collecting module 437. The state information collecting module 437 collects state information corresponding to the kind of state information included in the state information requesting message and outputs the collected state information to the device agent module 420. The device agent module 420 creates a state information message containing the state information and transmits it to the server 450 through the device interface module 425.

Upon receiving a request from the user, the server agent module 465 may supply a content being played by a specific displaying apparatus to the user through the user interface module 475. According to another exemplary embodiment of the present invention, the server 450 may comprise a content processing module (not shown) that processes any specific content (e.g., the content processing module 430 of the displaying apparatus 410 described above).

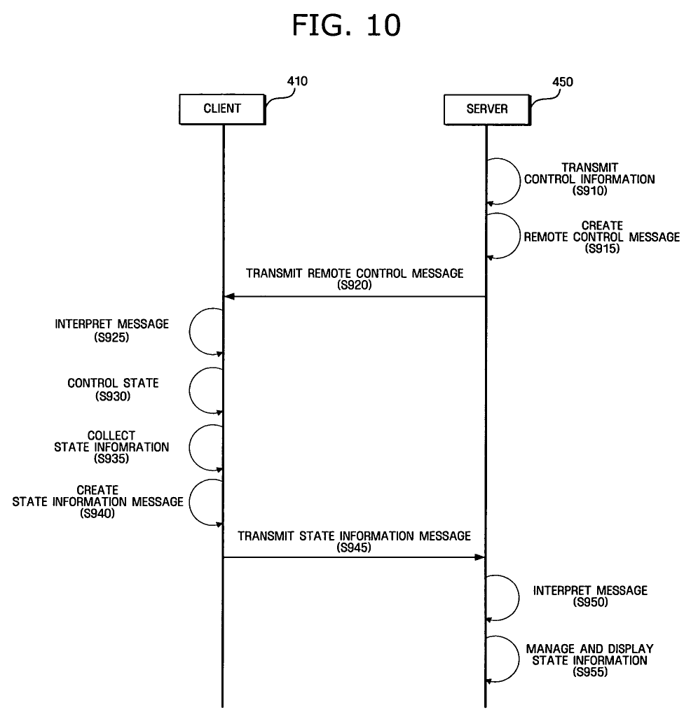

Remote control and watch between the displaying apparatus 410 and the server 450 will be apparently apprehended through FIGS. 9 and 10.

Furthermore, message communications are conducted between the displaying apparatus 410 and the server 450, which will be described hereinafter. For the sake of convenience, the displaying apparatus 410 is indicated as a client, and the block diagrams depicted in FIGS. 4 through 5B will be used in describing the present exemplary embodiment. At this time, creation of a message and interpretation of the received massage to perform the message communications are conducted by the server agent module 465 in the server 450, and by the device agent module 420 in the client 410.

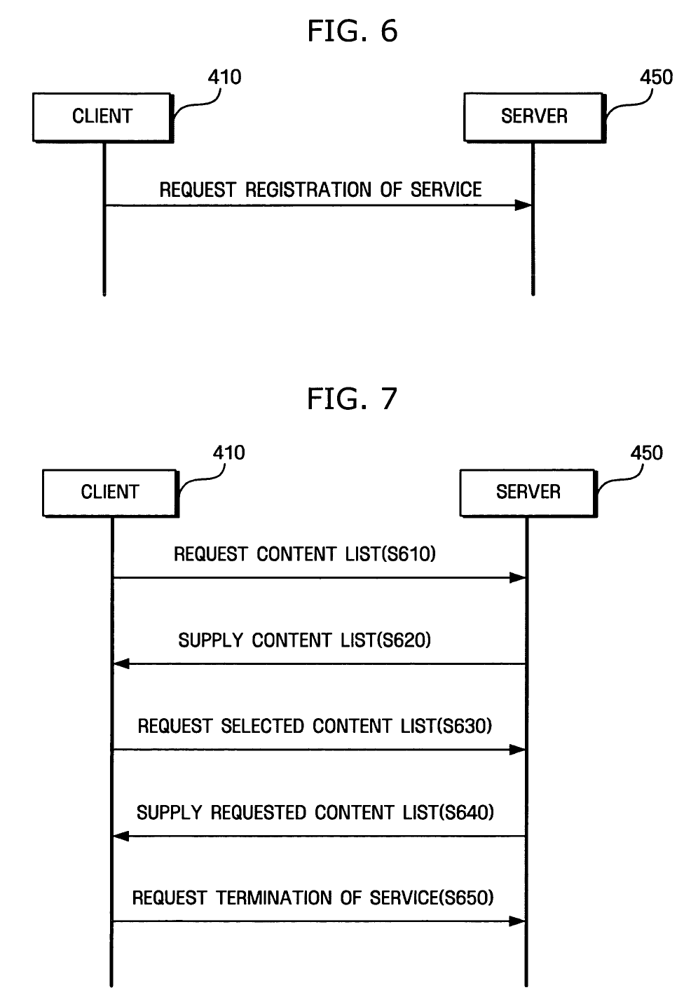

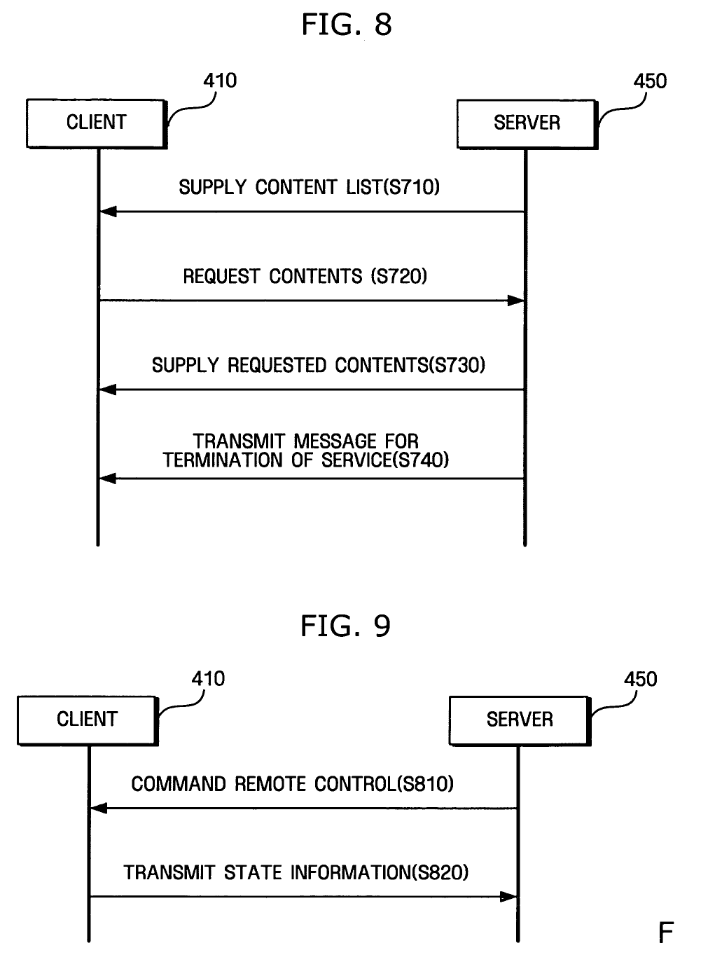

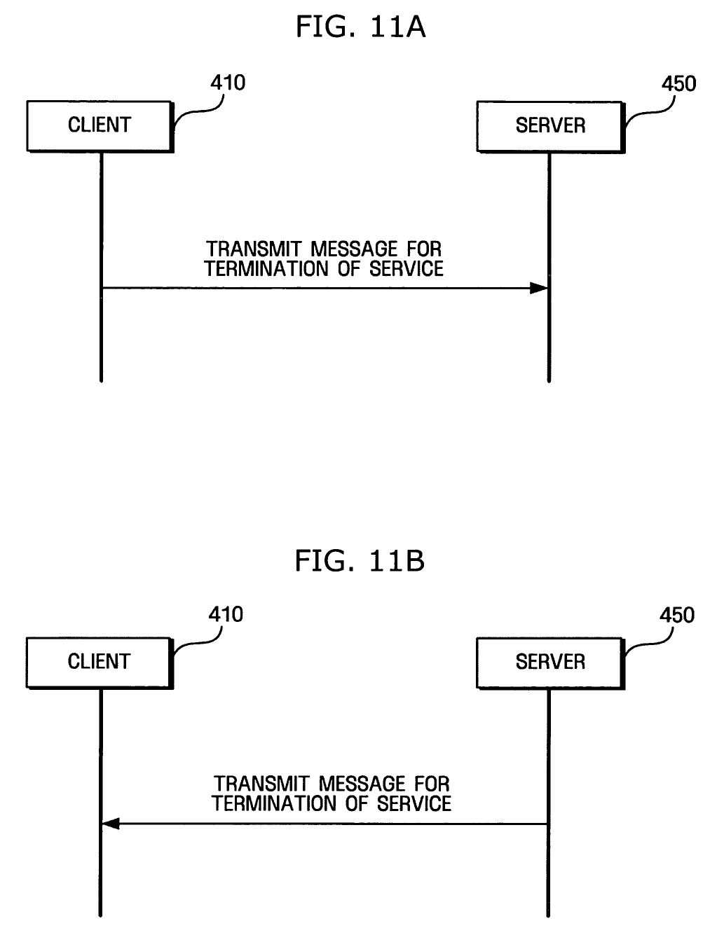

Roughly, the message communication protocol according to the present exemplary embodiment covers i) message communications to register a client as a service subscriber in the server and begin the service (see FIG. 6), ii) message communications by the client for Pull mode of the server (see FIG. 7), iii) message communications for Push mode from the server to the client (see FIG. 8), iv) message communications by the server for remote control of the client (see FIG. 9), and v) message communications for service termination between the client and the service (see FIGS. 11A and 11B).

Under the Pull mode service, the client actively receives a content stored in the server and outputs the received content. For example, where there is a server that supplies music songs, it may be understood that the client ascertains a list of music songs stored in a server supplying music songs and receives a target song desired by a user from the server.

Under the Push mode service, the client passively receives a content and outputs the received content, according to the control by the server. For example, where monitors (clients) supporting network functions are displaced on several places within waiting rooms of a train station or a bus terminal, the server transmits departure and arrival times of buses or trains, public notifications, movies or music songs, etc. to each monitor, whereby they are displayed on the monitors.

FIG. 6 illustrates registration by the client of services according to an exemplary embodiment of the present invention. To allow the client 410 to use services supplied by the server 450, information regarding the client 410 is to be registered with the server 450.

At this time, a message for this service registration has a payload containing the following data:
Payload for service registration message={MAC address, Service Type, Group Name, Client Name}.

‘MAC address’ refers to a proper identification allocated to a network card included in the device interface module 425, which is also used as an identifier to distinguish individual clients. Where there is a remote control by the server 450, the MAC address can also be used when turning on power of the client 410.

‘Service type’ refers to a proper identifier to distinguish services.

‘Group name’ refers to the name of group to manage clients.

‘Client name’ refers to an alias of each client accustomed to the user, to distinguish individual clients.

As depicted in FIG. 6, when the client 410 requests the server 450 to register a service using a service registration message, the server agent module 465 of the server 450 ascertains service type and group name contained in the service registration message. If the service type is consistent with service type supported by the server 450, and the group name belongs to a group managed by the server 450, the server agent module 465 stores information of the client 410 having requested the service registration in the storage module 470. At this time, the server 450 may be established so as to provide the service only to a specific group or to a client belonging to all the groups. The server 450 may manage a list of registered clients by group or supply differentiated services by group.

FIG. 7 illustrates a Pull mode service according to an exemplary embodiment of the present invention. The Pull mode service is performed when a target content desired in the content list of the server 450 is used by the client 410.

Messages to perform the Pull mode service have payloads containing the following data:
Payload for Pull mode content list requesting message={Service Type, Group Name, Client Name, Media Type, List Sorting Information, List Requesting Information},
Payload for Pull mode content list message={Service Type, Server Name, Media Type, Content List Information, Server Service Networking Information},
Payload for Pull mode content requesting message={Service Type, Group Name, Client Name, Content Information}, and
Payload for Pull mode content termination message={Service Type, Group Name, Client Name, Media Type}.

‘Media type’ indicates which kind of media a concerned content corresponds to, for example, movies, music, photographs or texts.

‘List sorting information’ indicates sorting information of a list including parameter data to sort, such as name, date, volume and genre of a file, etc.

‘List requesting information’ indicates number of lists by page, positions of pages, etc.

‘Content list information’ refers to a list of content information, that is, a list of contents to any specific media type.

‘Server service networking information’ refers to information to access a network providing the service of the server 450. For example, the ‘Server service networking information’ may contain an IP address or a port number of the client 410. When multicasting is requested by the kind of service, IP address or port number for multicasting may be included in the ‘Server service networking information’.

‘Content information’ refers to information about each content, comprising information which may include information about file name, file length, date of creation, genre, playing time, or thumbnail of the concerned content.

As illustrated in FIG. 7, under the Pull mode, the device agent module 420 of the client 410 requests the server 450 to send a content list for a specific medium through the device interface module 425 S610. At this time, the client 410 transmits the ‘Pull mode content list requesting message’ to the server 450.

The server agent module 465 of the server 450 ascertains whether it is consistent with the service type of its own and it is a member of the group authorized by the client 410. Then, the server agent module 465 creates a list by extracting contents corresponding to the specific medium from the contents currently in use by itself, and transmits the created content list to the client 410 by use of the ‘Pull mode content list message’ S620.

The client 410 selects a target content as desired from the received content list, and requests the server 450 to provide the selected content by use of the ‘Pull mode content requesting message’ S630.

The server 450 begins the Pull mode service to the requested content after having ascertained whether it is for its own service type or for an authorized client S640. If the client 410 desires to terminate the Pull mode service, it can terminate the Pull mode service operation by transmitting the ‘Pull mode content termination message’ to the server 450 in operation S650.

FIG. 8 illustrates a Push mode service according to an exemplary embodiment of the present invention. The Push mode service can be used when a content is supplied to the client 410 from the server 450 according to an operation by the scheduling module 460.

Messages to perform the Push mode service have payloads containing the following data:
Payload for Push mode content list message={Service Type, Server Name, Media Type, Content List Information, Server Service Networking Information},
Payload for Push mode content requesting message={Service Type, Group Name, Client Name, Content Information}, and
Payload for Push mode content termination message={Service Type, Server Name, Media Type}.

‘Server name’ refers to an alias of the server 450 accustomed to the user, to distinguish the server 450 from other apparatuses. Other terms contained in each message may be understood according to the above described exemplary embodiment.

As illustrated in FIG. 8, under the Push mode, the server 450 transmits a content list to the client 410 S710. The content list contains a list of contents to be output from the server 450 to the client 410. At this time, the server 450 may use the ‘Push mode content list message’.

The client 410 requests the server 450 to transmit the contents in the received content list sequentially, by use of the ‘Push mode content requesting message’ S720.

The server 450 begins the Push mode service to the requested content after having ascertained whether the client 410 is authorized and the service is consistent with its own service type S730. At this time, operations S720 and S730 are repeated for each of the contents contained in the content list received by the client 410.

Where the server 450 desires to terminate the Push mode service, it can terminate an operation for the Push mode service by transmitting the ‘Push mode content termination message’ to the client 410 S740.

FIG. 9 illustrates a remote control service according to an exemplary embodiment of the present invention, which may be used when states of the client 410, such as screen or sound mode, are remotely controlled, and the states of the client 410 are watched by the server 450. At this time, remote control messages and client state information messages for a remote control service can have the payloads containing the following data:
Payload for remote control message={Service Type, Server Name, Remote Control Command, Remote Control Command Parameter}, and
Payload for state information message={Service Type, Server Name, Client State Information}.

‘Remote control command’ refers to a control command for the server 450 to control states of the client 410. Examples of ‘remote control command’ include power on/off of the client 410, Wake On LAN, controls of contrast, tint, brightness, volume, screen mode, or sound mode, etc. The ‘Wake On LAN’ refers to turning on power of a CPU connected to a concerned network card by multicasting MAC address information of the network card to a network.

The ‘remote control command parameter’ refers to a concerned parameter to each remote control for loudness of volume, degree of brightness, etc.

The ‘client state information’ refers to state information of the client 410, such as volume, screen mode, sound mode, contrast, tint, and brightness of the client 410.

In addition, payloads for remote control message and for state information message may include a name of the client. Other terms contained in each message may be understood according to the above described exemplary embodiment.

As illustrated in FIG. 9, under the remote control service, the server 450 transmits a remote control command to the client 410, by use of a ‘remote control message’ S810.

The device agent module 420 of the client 410 interprets the message received from the server 450. If it is ascertained that the message is a command for remote control, the device agent module 420 transmits information regarding the received remote control command to the control and watch module 435. The control and watch module 435 conducts the corresponding command and reports any change in states of the client 410 as a result to the device agent module 420. The device agent module 420 transmits the state change reported from the control and watch module 435 to the server 450 through the device interface module 425 S820. At this time, the ‘state information message’ is transmitted together.

The server may request state information from a specific client. In this case, state information requesting messages may have the following payloads:
Payload for state information requesting message={Service Type, Server Name, State Information Request Command, Client Name}.

The ‘state information request command’ is an identifier to request the client to transmit a state information message. Other terms contained state information requesting message may be understood according to the above described exemplary embodiment.

The payload for state information requesting message may further include identification information to identify any specific state to be ascertained from the client. For example, identification information for volume state may be included to ascertain the volume level of the client, all identification information for state information of the client may be included to ascertain information of all the states, or identification information corresponding to all state information requests.

Examples of remote control and watch between the client 410 and the server 450 will be described with reference to FIG. 10.

To control a specific client, a user ascertains states of each client through a user interface provided by a user interface module 475.

When the user decides to control states of the specific client through the user interface module 475, the remote control module 482 responsively transmits the control information to the server agent module 465 S910.

The server agent module 465 having received the control information creates a remote control message including the control information S915. The created message is of the same type as described above with reference to FIG. 9. The created remote control message may contain remote control command and remote control command parameters.

The created remote control message is transmitted to the displaying apparatus 410 through the server interface module 455 S920.

When the client 410 has received the remote control message through the device interface module 425, the device agent module 420 interprets the received message S925.

Where the interpreted message includes control information, the device agent module 420 transmits the control information to the control module 438. The control module 438 controls a state of the client according to the control information received from the device agent module 420 S930. For example, if a remote control command included in the control information is relative to volume control and a remote control command parameter has a value 10, the control module 438 adjusts the loudness of the client's volume to 10.

When the control module 438 controls the displaying apparatus 410 according to the remote control message received from the server 450, the state information collecting module 437 senses any change in the states of the displaying apparatus 410 (for example, the changed loudness of the volume) and collects the state information S935.

The collected state information is transmitted from the state information collecting module 437 to the device agent module 420, and the device agent module 420 creates a state information message containing the transmitted state information S940. The state information message is the same as that described above with reference to FIG. 9.

The created state information message is transmitted to the server 450 through the device interface module 425 S945.

The state information collecting module 437 of the client 410 may collect state information of the client 410, although a control command is not received from the server 450, and transmit the state information to the device agent module 420. For example, the client 410 may comprise a user interface module (not shown) through which the user is allowed to directly control a state of the client 410. At this time, if the user directly controls the state of the client 410 through the user interface module of the client 410, the state information collecting module 437 senses any change in the state of the displaying apparatus 410 and collects the concerned state information, and transmits it to the device agent module 420. Further, the state information collecting module 437 may collect state information of the client 410 at regular intervals set up in advance and transmit it to the device agent module 420. Therefore, the operations after S930 or S935 may be independently conducted, although a remote control message is not received from the server 450.

The server agent module 465 having received the state information message of the client 410 through the server interface module 455 interprets the message S950 and transmits the state information of the client included in the message to the remote watch module 484.

The remote watch module 484 manages the state information collected from the client 410 S955. The remote watch module 484 also displays the state information of the client 410 to the user through the user interface module 475 S955. Accordingly, the user can remotely watch the state of the client 410 through the server 450.

The server 450 requests a concerned client to provide state information regularly or irregularly (that is, upon receiving a request from the user). In this case, the remote watch module 484 designates identification information of any target client desired to receive its state information or the kind of any target state information desired to receive and transmits it to the server agent module 465. The server agent module 465 creates a state information request message containing identification information of the client designated by the remote watch module 484 or the kind of state information and transmits it to the displaying apparatus 410 through the server interface module 455. The state information request message is the same as described above with reference to FIG. 9.

In this case, operation S910 can be replaced with an operation to request state information of the remote watch module 484, operation S915 can be replaced with an operation to create a state information request message, and operation S920 can be replaced with an operation to transmit a state information request message. Operations after S925, exclusive of S930, may be performed in the same manner.

Upon receiving a request from the user, the server agent module 465 may supply a content being played by a specific displaying apparatus to the user through the user interface module 475. The server 450 according to another exemplary embodiment of the present invention may comprise a content processing module to process any specific content (for example, the content processing module 430 of the displaying apparatus 410 described above).

FIGS. 11A and 11B illustrate termination of a service according to an exemplary embodiment of the present invention. The server 410 or the client 450 may be used in informing the counterpart of termination of its own service.

The message for service termination may have payloads containing the following data:
Payload for client service termination message={MAC Address, Service Type, Group Name, Client Name}, and
Payload for server service termination message={Service Type, Server Name}.

FIG. 11A illustrates service termination by the client 410. At this time, the client 410 transmits the ‘client service termination message’ to the server 450.

FIG. 11B illustrates service termination by the server 450. At this time, the server 450 transmits the ‘server service termination message’ to the client 410. Especially in this case, the service termination message is transmitted to all the clients connected to the server 450.

A message to confirm interconnection of the server 450 and the client 410 may be received and transmitted on a regular basis. By use of this message, it can be confirmed whether the counterpart is abnormally disconnected. The message for confirming the interconnection may have payloads containing the following data:
Payload for interconnection confirming message={MAC Address, Service Type, Group Name, Client Name}.

A method for remote control and watch by a server of a displaying apparatus and a system employing the same according to an exemplary embodiment of the present invention can control a plurality of displaying apparatuses having a function of message communications remotely through a single server, and watch any change occurred in physical states of the displaying apparatuses.

It will be understood by those of ordinary skill in the art that various replacements, modifications and changes in form and details may be made therein without departing from the spirit and scope of the present invention as defined by the following claims. Therefore, it is to be appreciated that the above described exemplary embodiments are for purposes of illustration only and not to be construed as a limitation of the invention.

What is claimed is:

1. A server comprising:
a remote control module that supplies control information to control a displaying apparatus coupled to the server by a network;
a server agent module that creates a remote control message containing the supplied control information;
a network interface module that transmits a specific message created by the server agent module to the displaying apparatus, and receives a state information message containing state information of the displaying apparatus from the displaying apparatus; and
a remote watch module that manages the state information included in the received state information message.

2. The server of claim 1, wherein the state information includes state information changed according to a control by the displaying apparatus based on the remote control message, or state information collected regularly by the displaying apparatus.

3. The server of claim 1, wherein the server agent module creates a state information request message requesting state information of the displaying apparatus regularly, or upon receiving a request from a user.

4. The server of claim 3, wherein the state information includes state information collected by the displaying apparatus according to the state information request message.

5. The server of claim 1, further comprising a user interface module through which to supply state information of the displaying apparatus to the user.

6. A displaying apparatus comprising:
a device interface module that transmits data to, and receive data from, a server coupled to the displaying apparatus by a network;
a state information collecting module that senses changes in state of the displaying apparatus, collects predetermined state information and outputs the collected state information;
a device agent module that interprets the received data when the received data includes a remote control message containing control information, and creates a state information message containing the collected state information; and
a control module that performs state control of the displaying apparatus according to the control information.

7. The apparatus of claim 6, wherein the state information collecting module collects and outputs state information periodically.

8. The apparatus of claim 7, wherein, when the received data is a state information request message requesting the state information, the state information collecting module collects and outputs the state information.

9. A method for remote controlling and watching, comprising:
supplying control information to control a displaying apparatus coupled to a network;
creating a remote control message including the supplied control information and transmitting the remote control message to the displaying apparatus;
receiving a state information message including state information of the displaying apparatus from the displaying apparatus, in response to the remote control message; and
interpreting the state information message and supplying the state information.

10. The method of claim 9, wherein the state information includes state information changed according to a control by the displaying apparatus based on the remote control message, or state information collected regularly by the displaying apparatus.

11. The method of claim 9, further comprising transmitting a state information request message requesting state information of the displaying apparatus to the displaying apparatus regularly, or upon receiving a request from a user.

12. A method for remote controlling and watching, comprising:
receiving a predetermined message from a server coupled to a network;
controlling a state of a displaying apparatus when the message includes a remote control message to control a state of the displaying apparatus;
collecting state information of the displaying apparatus changed according to the control; and
creating a state information message including the state information and transmitting the state information message to the server.

13. The method of claim 12, further comprising collecting state information of the displaying apparatus when the received message is state information message to request state information of the displaying apparatus.

14. The method of claim 12, further comprising collecting the displaying apparatus' own state information regularly.
